(19) United States
(12) Patent Application Publication
(10) Pub. No.: US 2009/0119364 A1
(43) Pub. Date: May 7, 2009

(54) METHOD AND SYSTEM FOR EXCHANGE OF DATA BETWEEN REMOTE SERVERS

(75) Inventor: Gerard Guillon, Mandelieu La Napoule (FR)

Correspondence Address: YOUNG & THOMPSON, 209 Madison Street, Suite 500, ALEXANDRIA, VA, 22314, US

(73) Assignee: OBERTHUR TECHNOLOGIES, Paris (FR)

(21) Appl. No.: 12/266,850

(22) Filed: Nov. 7, 2008

(30) Foreign Application Priority Data
Nov. 7, 2007 (FR) 0758864

(51) Int. Cl. G06F 15/173; H04L 9/32

(52) U.S. Cl. 709/203; 713/184

(57) ABSTRACT

A method and a system for exchanging data between a first server (131) housed in an electronic unit (130) linked to a programmable device (100) and a second remote server (110). The first and second servers are each individually addressable by the programmable device via respective target addresses and the method including the following steps:
reception (208) by the programmable device of a response to a first request, the response including the data and one of the target addresses;
execution (216) of the response by a browser (107) implemented on the programmable device in such a manner as to cause the transmission (218) of the data to the target address. The invention is notably applicable to transactions between servers.

The present invention relates to the field of computing and, more particularly, to the exchange of data between a server housed in an electronic unit and a remote server.

The boom in telecommunications technologies has allowed the convergence of the world of mobile telephony with that of the Internet. Thus, over the past few years, it has been possible to access Internet sites, over the mobile telephone network, from a Web browser installed on a mobile telephone.

The development of WAP protocol (Wireless Application Protocol) is notably known by means of which an onboard Web browser sends an HTTP (HyperText Transfer Protocol) request to a destination Web server of the Internet network.

This request is transported over the mobile telephony network and transmitted to the Internet network via an ad hoc gateway. The Web server then responds to the request by sending, via the same pathway, to the mobile Web browser a page in a format that the latter recognizes, for example WML (Wireless Markup Language) or XTML (eXtensible Telephony Markup Language).

Other formats such as HTML (HyperText Markup Language), PHP (recursive acronym for Hypertext Preprocessor), XML (eXtensible Markup Language), Javascript or equivalents may also be used.

Upon receiving it, the Web browser executes the page received in order to form a display on the display screen, generally the screen of the mobile telephone.

Here, and for the remainder of the document, the execution of the page by a browser may be understood as the interpretation of the instructions forming the page, for example HTML markers, in such a manner as to produce a display corresponding to the content of the page.

An increasingly large part of the applications implementing mobile telephones is processed inside the onboard SIM (Subscriber Identity Module) card, for reasons of security.

Thus, Web servers have appeared in smartcard devices, called ‘SmartCard Web Server’ devices, and also in a large number of portable electronic units, of the USB (Universal Serial Bus) stick or microcircuit (smartcard) card type.

It is observed that access to these onboard servers in an electronic unit is generally straightforward from a Web-type browser executed on the mobile telephone to which the electronic unit is connected.

On the other hand, communications between the server on such a smartcard linked to the mobile telephone and a remote server on the Internet network requires an adaptation of the browser and/or of the mobile telephone. Notably, the remote server must have access to an IP (Internet Protocol) address of the onboard server in order to communicate with the latter.

A banking transaction, during which a bank server controls an authentication process with a smartcard, is an example of application where this problem may be encountered.

A solution addressing this issue by use of SMS (Short-Message Service) is known from the document: Guthery et al., “How to turn a GSM SIM into a Web Server”, by Scotte Guthery, Roger Kehr and Joachim Possega, available at the Web address http://www.scdk.com/websim.pdf. In detail, the remote server sends requests to the server of the smartcard by means of SMS messages with commands in the envelope. This results in a direct communication between the two servers and the possibility for the remote server to control the command execution by the smartcard.

Nevertheless, this solution requires a dedicated server for the conversion of the requests into SMS messages and corresponding means on the smartcard for converting the SMS messages received into commands.

Moreover, this solution also has the drawback of carrying out transactions slowly owing to the speed of propagation of the SMS messages being of the order of several seconds (see paragraph 2.3.3 of this document).

Therefore, a need exists to provide a more efficient data exchange mechanism, notably a faster mechanism and/or not requiring any additional equipment.

For this purpose, a subject of the invention is notably a method for exchange of data between a first server housed in an electronic unit linked to a programmable device and a second remote server, said first and second servers being each individually addressable by the programmable device via respective target addresses, the method comprising the following steps:
a. reception by the programmable device of a response to a first request, said response comprising the data and one of said target addresses;
b. execution of said response by a browser, for example of the web type, implemented on the programmable device in such a manner as to cause the transmission of the data to the target address.

“Remote” is understood to mean the fact that, in order for the second server to be reached, there is a need to rely on a communications network, for example a mobile telephony network or the Internet. In particular, the second server is remote from the electronic unit (and from the device linked to it) in that the address of this server is not referenced as a local address for the electronic unit.

“Linked unit” is understood to mean any electronic unit that is integrated into the programmable device or that it is in position connected to the device when the unit is removable. In the integrated configuration, connecting means, notably electrical connectors, for example gold wires, are used in order to connect the electronic unit to other components of the device. In the removable configuration, it is common that the programmable device and the unit have corresponding interfaces for reception from the other equipment, these interfaces acting as connection means comprising connectors with the other equipment in order to provide a connection with the components of the other equipment.

Thus, this connection comprises a physical and electrical connection between the device and the unit.

In response to a first initial request, one of the servers thus transmits a response which is converted by the browser of the programmable device into a second request for the transmission of the data to the target address supplied, which corresponds in all probability to the other server.

Thus, the two servers communicate with one another via the browser that plays a role of gateway.

The terminology request/response implies that the browser plays a central role of controlling the exchanges between the two servers. A request corresponds to a query from the browser to one of the servers, whereas a response corresponds to a message supplied by a queried server to the browser.

Because of the central function of the browser, it is also possible to establish a three-way exchange of data, or even between more than three servers.

The invention can notably make use of the pre-existing web browser mechanisms in order to create this gateway function. A data exchange method is thus obtained that does not require the addition of an supplementary server or module. Moreover, the mechanisms of a browser do not introduce any latency time compared with an SMS message network. Thus, the invention provides a very fast method.

It should be noted that the method according to the invention may be applied in both directions of communication between the two servers.

In one embodiment, the first initial request could come from an initial request from the other server to said browser. Thus, the invention includes the reiteration of steps a) and b), and said emission of an iteration comprises the transmission of said first request of the following iteration. A continuous looping of the requests and responses between the browser and the servers is thus effected, making possible the establishment of complex exchanges of data between servers.

In one embodiment, said response is transmitted according to the HTTP protocol. The first or second server, emitter of the data and of the response, is therefore an HTTP server.

In one embodiment, said transmission of the data (request transmitted by the browser) to the target address is carried out according to the HTTP protocol. In this case, the first or second destination server for the data is a web server implementing the HTTP protocol.

In one variant, said transmission of the data to the target address is carried out according to the FTP protocol (File Transfer Protocol). In this case, the first or second destination server for the data is an FTP server.

In one embodiment, said response comprises a command designed to be executed by said browser. It is notably intended that this command be based on conventional mechanisms, for example HTTP and HTML, of a web browser in such a manner that no ‘plug-in’ is required.

According to one particular feature, said command is included in the body of said response, in other words the command is in a page designed to contain the data to be transmitted. This page is notably established according to conventional standards, for example an HTML page, an XML page, an XHTML (eXtensible HyperText Markup Language) page, with or without JavaScript (non-commercial) script. More precisely, the command can also be in the body of the page in question, and the body can for example be bounded by ad hoc markers, for example <body> and </body> in HTML language. The command may, optionally, be placed within the header of the page in question. Equally, the command may be included within a JavaScript script.

As a variant, said command is included in the header of said response. The web browser should then be designed to interpret the header of the response in order to execute the command. One possible solution consists in modifying the HTTP standard so as to include in it a specific field dedicated to a command to be executed.

According to another particular feature, said command comprises said target address, for example as a parameter. The command may also comprise the data, for example as a parameter.

According to another particular feature, said command comprises a command for sending an HTTP request.

In particular, said send command comprises an external link to an HTTP server. This external link may notably be in the form of a URL (Uniform Resource Locator) address redirection, for example according to the format:

<meta http-equiv=“Refresh” content=“TIME; url=http:

//www.example.com/”>

where TIME is a refresh time delay (in seconds) to be set. In this case, according to the direction of communication between the servers, the destination server is an HTTP server.

In particular, said request is designed to be according to the securitized HTTPS protocol.

According to another particular feature, said command comprises a send command for an FTP request.

In particular, said send command comprises an external link to an FTP server. This external link can notably be in the form of a URL address redirection (use of the URL in the format ftp://ftp.example.com/). In this case, according to the direction of communication between the servers, the destination server is an FTP server.

In one embodiment, it is provided that said command designed to be executed by said browser comprises a local command designed to be executed in the destination server for the data, for example an APDU (Application Protocol Data Unit) command. Thus, the browser executing the first command mentioned will transmit the local command to the destination server for local execution, either directly by the server or by a destination application.

Notably, said local command preferably complies with the ISO 7816 standard.

Also, said data are passed as parameters of the local command.

In one embodiment, said transmission of the data comprises the transmission of a request, for example HTTP or FTP, and the method then comprises a step for converting said request into a command compatible with communication means provided within said electronic unit.

The conversion can be of the type where said request is encapsulated within a packet compatible with a standard for communication with the electronic unit, or of a type where the instructions and data are reformatted into a command compatible or a mix thereof. This can be notably a conversion which is compatible with one of the OMA (Open Mobile Alliance) standards, for example the standard OMA-TS-Smartcard_Web_Server-V1.

In one embodiment, said electronic unit comprises an HTTP server.

In one embodiment, said electronic unit is designed to be connected in a removable manner to said programmable device, for example by means of a USB interface or an ISO 7816 interface. Thus, the method can comprise an initial step for connection of said electronic unit to said programmable device so as to form a communications link.

In one embodiment, said electronic unit has no separate power supply. An electronic unit of reduced size is thus obtained, which may be easily mounted onto or connected to the programmable device.

Thus, said electronic unit may be designed to comprise a USB stick.

As a variant, said electronic unit comprises a microcircuit card.

According to one particular feature, said card conforms to the ISO 7816 standard.

According to another particular feature, said card comprises a memory card, for example of the MMC (Multimedia Memory Card) type.

In another variant, said electronic unit comprises a mobile telephony card. In this case, said card can be of the SIM type, notably of the USIM (Universal Subscriber Identity Module) type. It may then be envisioned that the programmable device is a mobile telephone.

As an alternative to the removability of the unit, said electronic unit is designed to comprise a microcircuit module integrated into said programmable device and housing said first server. The resulting system exhibits an enhanced design and integration simplicity, and the associated fabrication costs are thus reduced.

In particular, said microcircuit module is capable of wireless communication, for example according to the NFC (Near Field Communication) standard. This configuration allows the module, on the one hand, to converse for example with an external reader or terminal and, on the other, to solicit an exchange of data with a second remote server.

As an alternative, the invention allows the NFC means of communication and the first server to be housed on two separate interconnected microcircuit modules.

In one embodiment, said electronic unit is designed to be securitized according to common criteria or to the FIPS standard.

According to one feature of the invention, said electronic unit comprises cryptographic means, notably an encryption key.

In one embodiment, said programmable device comprises a personal computer. In particular, said programmable device is a mobile telephone.

In one embodiment, said second remote server and said programmable device communicate over at least one telecommunications network. Said telecommunications network notably comprises a mobile telecommunications network, in which case it may be envisioned that the programmable device is a mobile telephone.

According to one configuration of the invention, said electronic unit is a removable, portable and/or a pocket device. Pocket device is understood to mean any equipment that is easily transported by a user in his pocket, notably of limited size complying with a volume of less than 100 ml and a longest side less than 15 cm, preferably complying with a volume of less than 20 ml and a longest side less than 5 cm. The portability for example of authentication means is thus enhanced and, for a user, the transport on his person of his own authentication information is simplified.

In one embodiment, at least one of said addresses comprises an IP address. This embodiment allows ready use to be made of the pre-existing infrastructures and mechanisms in order to manage the IP protocol.

The invention also relates to a method of authentication between a first and a second server, comprising an exchange of tokens based on a Challenge-Response mechanism (conventional authentication mechanism) by the exchange of data according to the method described hereinabove.

Another subject of the invention is a system for exchange of data between first and second servers, the system comprising a first server housed in an electronic unit linked to a programmable device and a second remote server, said first and second servers being each individually addressable by the programmable device via respective target addresses, the programmable device comprising:
means for receiving a response to a first request, said response comprising the data and one of the target addresses; and
a browser designed to execute said response in such a manner as to cause the transmission of the data to said target address.

The advantages of this system are similar to those of the corresponding method.

Optionally, the system can comprise means relating to the data exchange method features presented hereinabove.

Notably, said browser can be designed to transmit said data in the form of a request, and said system then comprises means for converting said request into a command compatible with communication means provided within said electronic unit.

By more precisely separating the roles, on the one hand, of the first local server and, on the other, of the second remote server, another subject of the invention is a method for transmission of data from a remote server to a destination server housed in an electronic unit addressable via a target address by a programmable device implementing a browser. The transmission method notably comprises a step for transmission, in response to a first request, by the remote server to the programmable device, of a response readable by the browser and comprising the data, the target address and an instruction to redirect the data to the target address.

Thus, the browser of the programmable device, by the effect of the redirection instruction that it implements, also plays a role of gateway between the two servers. Advantages similar to those of the data exchange method hereinabove are thus obtained by this transmission method.

Optionally, the method may comprise any part of the data exchange method features presented hereinabove.

Notably, the redirection instruction can take the form of a command within the response, for example HTTP. Thus, the redirection can comprise an external link to the HTTP or FTP server.

In one embodiment, said command comprises a local command capable of being executed by the electronic unit. The term ‘local’ refers to the electronic unit, such that the local command may be interpreted and executed by an application implemented by the electronic unit.

This embodiment allows the remote server to send commands, in an efficient manner, to the electronic unit and thus to control it.

According to one particular feature, said local command conforms to the ISO 7816 standard. In this embodiment, the onboard server recovers and extracts, from a later request transmitted by the browser in reaction to the redirection command, the local command and transmits it to a command execution system according to the ISO 7816 standard, for example an operating system of the electronic unit, for the execution of this command.

According to another particular feature, said data are passed as parameters of said local command. This embodiment allows the remote server to control the electronic unit efficiently and precisely, notably by acting on the data to be transmitted, in other words on the parameters of the local command which is ultimately executed by the electronic unit.

In one embodiment, said electronic unit comprises an FTP server. This embodiment preferably corresponds to the scenario where the command comprises a command to send an FTP request (to the server in question).

Another subject of the invention is a server comprising transmission means designed to transmit, in response to a first request and destined for a programmable device implementing a browser, a response readable by the browser and comprising data, a target address of a second server housed in an electronic unit linked to said programmable device and an instruction for redirecting the data to the target address.

Optionally, the server can comprise means relating to the features of the data transmission method presented hereinabove.

On the other hand, another subject of the invention is a method for transmission of data from a first server, housed in an electronic unit linked to a programmable device implementing a browser, to a second remote destination server having a target address. The method notably comprises a step for transmission, in response to a first request, by said first server and destined for the programmable device, of a response readable by the browser and comprising the data, the target address and an instruction to redirect the data to the target address.

Thus, the browser of the programmable device, by the effect of the redirection instruction that it implements, also plays a role of gateway between the two servers. Advantages similar to those of the data exchange method hereinabove are thus obtained by this transmission method.

Optionally, the method can comprise any part of the data exchange method features presented hereinabove.

In one embodiment, the method comprises an initial processing step carried out by said electronic unit so as to generate said data. Thus, the data transmitted by the method according to the invention come from a processing operation on the electronic unit.

The processing operation can notably comprise cryptographic processing, for example of the encryption/decryption or signature/authentication type, using a key stored in the electronic unit and cryptographic means provided for this purpose in the unit.

Equally, said processing operation can implement third-party data received by the electronic unit according to the method for transmission from a remote server to the onboard server, subject of the invention. It is thus observed that the invention allows a method for exchange of data in both directions of communication between the remote server and the onboard server.

It is accordingly possible to send commands to an electronic unit, for example a card, which, in return, delivers a response to the remote server.

Another subject of the invention is an electronic unit comprising a first server and means for connection to a programmable device implementing a browser, said first server comprising:
transmission means designed to transmit, in response to a first request and destined for the programmable device, a response readable by the browser and comprising data, a target address of a second remote server and an instruction to redirect data to the target address.

Optionally, the unit can comprise means relating to the data transmission method features presented hereinabove.

In one embodiment, said connection means comprise a USB interface.

According to one variant, said connection means comprise an interface according to the ISO 7816 standard.

The features and advantages of the present invention will become more clearly apparent upon reading a preferred embodiment illustrated by the appended drawings, in which:

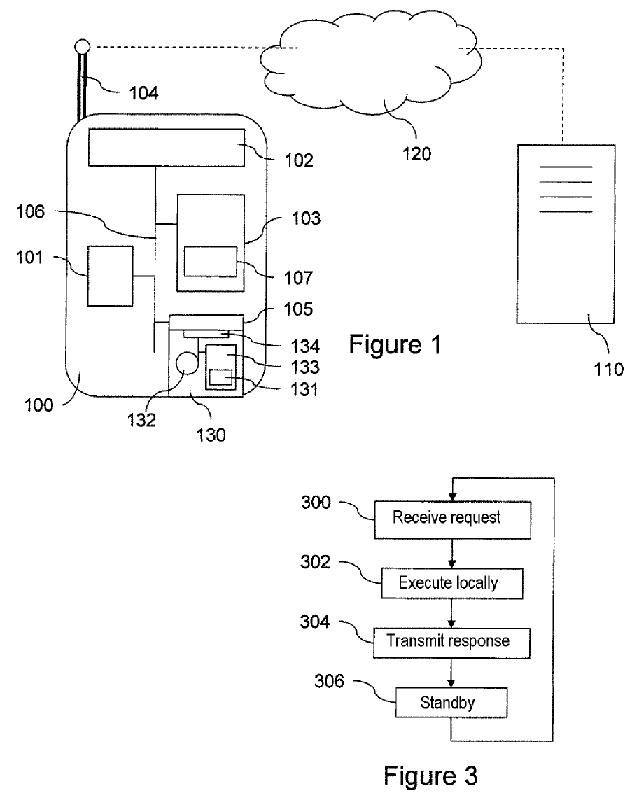

FIG. 1 illustrates an example of system for implementing the present invention;

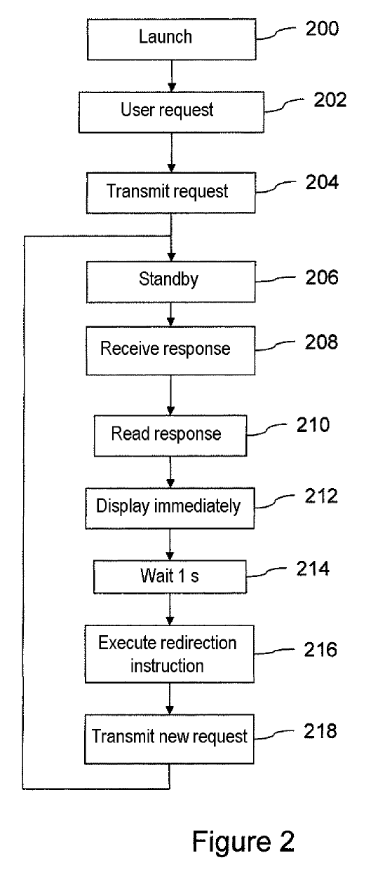

FIG. 2 shows, in the form of a logical diagram, the various processing steps carried out by the web browser in FIG. 1; and

FIG. 3 shows, in the form of a logical diagram, the various processing steps carried out by the two web servers in FIG. 1.

With reference to FIG. 1, an example of system for implementing the invention is shown. This example is based on a mobile telephony and Internet access solution for a banking transaction. It goes without saying that the explanations provided hereinafter can be applied to any type of programmable device, not only a mobile telephone, to any type of network and for any type of application requiring an exchange of data between two servers.

In the example in FIG. 1, a user is represented by a mobile telephone 100 and a banking transaction operator, for example a bank, is represented by a server 110, for example an HTTP Web server or an FTP server.

The two pieces of equipment 100 and 110 are interconnected via one or more networks 120. Although FIG. 1 only shows a single cloud as network, it is conventional, in view of the mobile telephone Internet access applications already in existence, that the two devices be interconnected over a mobile telephony network of the GSM (Global System for Mobile Communications) type (to which the mobile telephone 100 directly connects) and an IP network (to which the web server 110 is connected). The two networks are connected by means of a gateway designed to convert data from one of the formats into the other format of the two networks (not shown). Thus, the mobile telephone 100 and web server 110 can exchange data via the two networks 120.

The web server 110 is a conventional banking server which implements, in addition to web server means capable of managing HTTP requests, authentication means and transaction means (not shown), and which possesses means of communication over the network 120. Access to this server, from the network 120, is achieved by means of a web page reachable by means of an Internet address, for example https://www.mybank.com/HomeBanking.cgi. The application HomeBanking.cgi notably implements the banking transaction process.

The mobile telephone contains operational components, notably a CPU (central processing unit) 101, a display screen 102, one or more memories 103, for example a ROM and a RAM, means of communication 104 with the network 120 and an interface 105 with an electronic unit 130.

These components are interconnected by means of a data bus 106.

The CPU 101 is capable of executing applications held in memory 103, notably an onboard operating system (not shown) enabling the conventional operation of a mobile telephone.

The memory 103 also comprises an application of the known Web browser type 107, executable by the central processing unit 101, in order to allow the user to access the remote Internet network, for example via the WAP protocol previously mentioned. A keyboard or input device (not shown) provided on the mobile telephone 100 allows the user to interact with the web browser 107 when the latter is executed by the CPU 101. The display supplied by the web browser 107 is displayed on the screen 102 of the telephone 100.

The connection interface 105 enables the interconnection of the electronic unit 130 with the bus 106 and therefore with the other components of the telephone. Various types of interfaces 105 may be provided either alone or in combination, notably depending on the units 130 used. The following may be mentioned: USB interfaces able to receive removable USB units, ISO 7816 interfaces having connecting lugs for receiving microcircuits or SIM cards complying with this standard, MMC interfaces.

The electronic unit 130 is notably lacking independent power supply means, in other words batteries or equivalent, and is powered, for its operation and via the interface 105, by the power supply (not shown) of the mobile telephone 100.

The electronic unit 130 can be removable, in order to allow simple maintenance and/or replacement facilitated so as to obtain new functionalities provided by this unit. However, the invention is also applicable to units 130 fixed into the mobile telephone 100.

For the following part of the description, a single electronic unit 130 of the SIM smartcard type is considered, such as is currently found in mobile telephones.

The smartcard or any electronic unit 130 comprises a smartcard server 131, for example a smartcard web server, an execution means of the CPU type 132, a memory 133 for storing applications (notably the web server application, but also dedicated applications such as an authentication application) and means of communication 134 with the interface 105.

In the example described, the server 131 allows an application to be executed that comprises, stored in memory 133, a home page 201.html, an authentication page initAuthent and a page processAPDU.

The communication means 134 comprise the physical connection, by electrical contacts, of the SIM card 130 to the interface 105 together with an application (not shown) in memory and capable of communicating in an applicative manner with the components of the mobile telephone 100.

For communications with the components of the mobile telephone 100, and notably the web browser 107, the SIM card 130 is identified by means of a standardized address according to the standard OMA-TS-Smartcard_Web_Server-V1.

For example, the network address 127.0.0.1:3516 is taken for identifying the SIM card 130 on a conventional TCP (Transmission Control Protocol) channel and the network address 127.0.0.1:4116 for identifying the SIM card 130 on a secure TCP channel (TLS or Transport Layer Security channel).

In practice, the OMA standard can be implemented by means of a software application (not shown) executed, preferably continuously, on the mobile telephone 100. The software application supports the BIP protocol (Bearer Independent Protocol, notably according to the standard ETSI TS 102 223) in order to manage the communication with the SIM card 130. The application listens continuously to the ports 3516 and 4116 of the address 127.0.0.1. It converts the HTTP requests emitted by the browser 107 into APDU commands destined for the server 131 of the SIM card 130, and transmits them to the card, and converts the APDU responses emitted by the card 130 into HTTP responses for transmitting them to the browser 107. In this configuration, the server 131 can take the form of an ad hoc applet.

Another standard that may be envisioned is to use the name “localhost” as local reference for the computer and known to the operating systems. Thus, the corresponding addresses provided are localhost:3516 and localhost:4116.

A further addressing scheme envisioned comprises the use of the name “smartcard”, in principle not known to the local system, in order to identify the SIM card 130. IP address resolution means should then be provided in order to associate this name with the corresponding IP address, for example 127.0.0.1:4116 for a secure TCP channel. An additional DNS (Domain Name System) server is notably used to carry out this resolution operation, this server preferably being housed in the mobile telephone 100.

The exemplary application of a banking transaction implementing the invention is now described with the aid of HTML page bodies. Although this example is based on application protocol data units (APDUs), it is possible to envision the use of actions mentioned in the requests sent to, and processed by, the web server 131.

In order to access the transaction application, the user loads the following page 201.html into the web browser 107 of his telephone 100:

<HTML>

<HEAD>

<TITLE>Smart Web</TITLE>
</HEAD>

<BODY>

<a href=“http://smartcard/initAuthent>Banking</a>

</BODY>

</HTML>

When the user clicks on the link Banking, the page initAuthent is called up and the card generates in consequence an HTTP response comprising this page. The function of this page is to verify the PIN (Personal Identification Number), for example using four digits:

<HTML>

<HEAD>

<TITLE>Home banking PIN</TITLE>

</HEAD>
<BODY>

<FORM action=“verifyPIN” method=“post” name=

BankingPIN>

Enter your home banking PIN

<INPUT type=“password” name=“PIN” size=“4”

maxLength=“4”>

</FORM>

</BODY>

</HTML>

The user then inputs his PIN into the form displayed by the browser 107 and hits <enter>, which transmits an http request to the server 131 housed in the SIM card 130.

The PIN is then verified by the SIM card 130. If the PIN is good, the SIM card 130 will initiate a connection (for the transaction) with the transaction server 110 by generating an HTTP response to the request, the response containing the next HTML page. The browser 107 displays this page to the user on the screen 102.

<HTML>

<HEAD>

<TITLE>PIN correct</TITLE>
<META http-equiv=“Refresh” content=

“1;

URL=https://www.mybank.com/HomeBanking.cgi”>
</HEAD>
<BODY>

Please wait, card application selected...

</BODY>
</HTML>

It will be noted here that the meta-data identified by the marker <META> comprises an automatic redirection, here after content=1 second, to the address of the banking server 110, here https://www.mybank.com/HomeBanking.cgi, over a secure channel. Thus, at the end of this 1 second period, the browser transmits an HTTP request to the address previously specified, here the banking server 110 and its main page.

Upon receiving the request, the transaction server 110 then undertakes an identification procedure for the SIM card 130 by the execution of the application HomeBanking.cgi called up. This procedure implements an internal authentication procedure involving sending a random value to the SIM card 130. In response to the request, the banking server 110 sends back to the browser 107 an HTTP response comprising the following HTML page:

<HTML>
<HEAD>

<TITLE>Authentification de la carte</TITLE>
<META http-equiv=“Pragma” content=“no-cache”>
<META http-equiv=“Refresh” content=

“1; URL=http://smartcard/processAPDU?ID=123&AP

DU=03880000089A52C6B767932ED500”>

</HEAD>
<BODY>

Please wait, card authentication in progress...

</BODY>
</HTML>

It is noted here that the data is contained within the random APDU command 03880000089A52C6B767932ED500 to be transmitted to the SIM card 130. The random value is thus passed as a parameter of the redirection command bounded by the marker <META>. The message included between the markers <BODY> is displayed on the screen 102 of the user, then after 1 second (content=1), the browser transmits a request HTTP destined for the SIM card 130 and calling up the page processAPDU.

The data value ID=123 allows the smartcard 131 to be identified with which transaction is in progress, in the knowledge that the banking server 110 can carry out several simultaneous transactions with various SIM cards 131. This identifier 123 accordingly thus appears in the various exchanges of data between these two servers.

Upon receiving it, the smartcard web server 131 executes this page taking into account the parameters passed, here in particular the random number contained in the APDU command. According to a conventional procedure, the SIM card 130 encrypts this random number by means of a symmetrical key (as an alternative, the use of asymmetrical keys allows a similar authentication to be carried out) that it stores in its memory using dedicated cryptographic means, then returns this encrypted data to the banking server 110. For this purpose, an HTTP response is sent to the browser 107, comprising the following HTML page:

<HTML>

<HEAD>

<TITLE>Card authenticated</TITLE>
<META http-equiv=“Pragma” content=“no-cache”>
<META http-equiv=“Refresh” content=

“1; URL=https://www.mybank.com/HomeBanking.cgi

?ID=123&Answer=672F9DD49000”>

</HEAD>
<BODY>

Please wait, card authenticated...

</BODY>
</HTML>

The browser 107 thus displays the message “Please wait, card authenticated . . . ” to the user. After 1 second, the browser 107 generates a new HTTP request destined for the banking server 110 (https://www.mybank.com/) and comprising the encrypted data value in the APDU response 672F9DD49000.

Upon receiving it, the banking server 110 can verify this encrypted data with the aid of the symmetrical key of the server 110 so as to confirm the authentication of the parties so that the banking transaction proper can take place. This verification notably consists in calculating the encrypted value with the aid of the symmetrical key of the server and of the random number sent, and in comparing this encrypted value with the value received.

Thus, when the SIM card 130 is identified, the banking server 130 displays the home page of the home banking service having guaranteed the presence of the SIM card 130. As a variant, this authentication enables a banking or financial transaction to be triggered, for example according to the EMV (Europay Mastercard Visa) standard.

For sensitive operations (transfers from account to account, for example), the server 110 is, in the same way, able to communicate with the SIM card 130 in order to validate this operation (which will thus only be possible by having the security element and the associated PIN).

The initiation of the data exchanges according to the invention may lead to more complex operations than simply clicking a link on an HTML page.

By way of example, the electronic unit 130 can be an NFC secure microcircuit module integrated among the components of the mobile telephone 100. The NFC module is used in a banking transaction application with a wireless payment terminal. Because of the short wireless range specified in the NFC standard, the use of such an NFC module guarantees the implicit agreement of the user in the transaction with the terminal.

When the user wishes to pay for a purchase, he brings his telephone 100 equipped with the NFC module 130 up close to the payment terminal of the vendor. A communication is established in a conventional manner between the two devices in order to carry out the transaction.

This transaction can notably comprise the verification, by the terminal, of identification or validity data present in the secure NFC module 130. In the case where these data values are out-of-date or where other data are required in order to continue with the transaction, the NFC module 130 then initiates a procedure to recover this data from a remote server 110 according to the subject of the invention.

This initiation of the recovery procedure can comprise an execution command for the browser 107 emitted by the NFC module 130. For example, this command specifies to the browser to load an HTML page which comprises, in its header, an automatic redirection toward the initAuthent page of the NFC module 130.

Thus, by this command, the NFC module 130 launches a first HTTP request emitted by the browser 107 following which responses and other HTTP requests will succeed according to the invention.

In order to guarantee a high level of confidence in an NFC processing module or equivalent unit 130, it is ensured that the latter is securitized in accordance with either common criteria or the FIPS standard. Thus, access to the data from the NFC module 130 by a remote server 110 is all the more difficult and the invention keeps communication between these two units 130 and 110 possible.

According to an alternative embodiment, sharing of the functionalities of the NFC module 130 hereinabove between two separate interconnected modules may be provided: on the one hand, a server unit, for example a smartcard, and, on the other, an NFC unit for communicating with the external terminal.

With reference to FIG. 2, the behavior of the web browser 107 is shown in the example in FIG. 1 for the exchange of data between the two servers 131 and 110.

At step 200, the user launches the web browser 107 which then initiates a specific execution context and displays a page requested by the user (201.html in the example hereinabove).

At step 202, the user selects an action from the displayed page; here he clicks the Banking link.

At step 204, the browser 107 sends an HTTP response to a previous request, destined for one of the servers 131 and 110 depending on the user request, here to the SIM card 131.

Then the browser 107 goes into standby (step 206).

At step 208, the web browser 107 receives an HTTP request from one or other of the two servers 131 and 110.

At step 210, the browser 107 reads the information contained in the response. In practice, it interprets the markers from an HTML page.

At step 212, the browser 107 immediately displays, on the screen 102, the messages (for example “Please wait, card authenticated . . . ”) contained in the body of the HTML page.

At step 214, it waits for a period of content=1 second (depending on the parameters passed in the HTTP request).

Then, at step 216, the browser 107 executes the redirection instruction contained in the marker <META>. This execution causes the transmission (step 218) of a new HTTP request (for example GET https://www.mybank.com/HomeBanking.cgi?ID=123&Answer=672F9DD49000) destined for the other server 131 or 110. In this request, the transmission of one or more data values passed as parameters of the call for the page HomeBanking.cgi is noted.

It may however be envisioned to transmit this data in another way, for example by the transmission of a file containing this data and that the browser 107 sends within the HTTP request (or FTP according to another embodiment) destined for the other server.

The browser 107 then returns to a wait state (step 206) until it receives another HTTP response, generally the response originating from said other server.

With reference to FIG. 3, the similar behavior of the two web servers 131 and 110 is shown.

At step 300, the server in question receives an HTTP request coming from the browser 107. This request notably comprises data passed as parameters (random number, encrypted or otherwise, in the example hereinabove).

At step 302, the server executes, where necessary calling up other applications locally, a processing operation (here the generation of a random number for the server 110 and the encryption of this number for the server 131) using for example the data passed as parameters.

At step 304, the server in question transmits an HTTP response to the browser 107.

In the preceding example, this response comprises an HTML page notably comprising a redirection instruction toward the other server and the result of the preceding processing operation as data passed as parameters of this instruction.

At step 306, the server goes into standby waiting for a new request (processed at step 300).

Accordingly, it is possible to make two remote servers belonging to separate environments (networks) communicate efficiently without the need for new modules or equipment absent from the current programmable devices.

It should be noted that the authentication steps described in the example hereinabove form a first phase which can be followed by a financial or banking transaction phase proper, which is not described in a detailed manner here and which may, nevertheless, rely on exchanges of (transaction) data according to the subject of the invention.

The preceding examples are only exemplary embodiments of the invention to which it is not limited.

In particular, the electronic unit 130 can be a mass storage device, for example of the USB stick or memory card (for example MMC) type. In this case, the microcontroller of the mass storage device is adapted to and designed for the execution of a streamlined web server application.

The mobile telephone 100 is also designed to continuously implement a software application allowing the communication (and the conversions to the correct format) between the browser 107 and the mass storage device 130 according to a compatible protocol. For example, one solution adopted consists in the software converting the http requests and responses (from and to the browser 107) to and from a data file stored in the mass memory by using the basic commands for writing to/reading from a mass storage device.

Thus, the microcontroller can readily read this file (write to this file, respectively) and recover (transmit, respectively) the content of an HTTP request emitted by the browser (of a response destined for the browser, respectively).

1. Method for exchange of data between a first server (131) housed in an electronic unit (130) linked to a programmable device (100) and a second remote server (110), said first and second servers being each individually addressable by the programmable device via respective target addresses, the method comprising the following steps:
a. reception (208) by the programmable device of a response to a first request, said response comprising the data and one of said target addresses;
b. execution (216) of said response by a browser (107) implemented on the programmable device in such a manner as to cause the transmission (218) of the data to said target address.

2. Method according to claim 1, in which the steps a) and b) are reiterated, and said transmission (218) of an iteration comprises the transmission of said first request of the following iteration.

3. Method according to claim 1, in which said first and second servers are HTTP servers implementing the HTTP protocol for the transmission of said response and the transmission of said data to the target address.

4. Method as claimed in claim 3, in which said response comprises an HTML page for verification of a user PIN code.

5. Method according to claim 1, in which said response comprises a command designed to be executed by said browser (107).

6. Method according to claim 1, in which said command comprises said target address.

7. Method according to claim 1, in which said command comprises a command for sending an HTTP request.

8. Method according to claim 7, in which said send command comprises an external link to an HTTP server.

9. Method according to claim 5, in which said command designed to be executed by said browser comprises a local command according to the ISO 7816 standard designed to be executed on the data destination server, and said data are passed as parameters of the local command.

10. Method according to claim 1, in which said transmission (218) of the data comprises the transmission of a request, the method comprising a step for converting said request into a command compatible with communication means provided in said electronic unit.

11. Method according to claim 1, in which said electronic unit (130) is designed to be connected in a removable manner to said programmable device (100), and the method comprises an initial step for connection of said electronic unit to said programmable device so as to form a communications link.

12. Method according to claim 1, in which said electronic unit (130) comprises a mobile telephony card.

13. Method according to claim 1, in which said programmable device (100) is a mobile telephone.

14. Method according to claim 1, in which said second remote server (110) and said programmable device (100) communicate over at least one mobile telecommunications network (120).

15. Method according to claim 1, in which at least one of said addresses comprises an IP address.

16. Method according to claim 1, in which said data are banking transaction data.

17. Method for authentication between a first and a second server, comprising a token exchange based on a Challenge-Response mechanism by the exchange of data according to claim 1.

18. System for exchange of data between a first and a second server, the system comprising a first server (131) housed in an electronic unit (130) linked to a programmable device (100) and a second remote server (110), said first and second servers being each individually addressable by the programmable device (100) via respective target addresses, the programmable device comprising:
means for receiving a response to a first request, said response comprising the data and one of the target addresses; and
a browser (107) designed to execute said response in such a manner as to cause the transmission of the data to said target address.

19. System according to claim 18, in which said browser is designed to transmit said data in the form of a request, said system comprising means for converting said request into a command compatible with communication means provided in said electronic unit.

20. Method for transmission of data from a remote server (110) to a destination server (131) housed in an electronic unit (130) addressable via a target address by a programmable device (100) implementing a browser (107), characterized by a step for transmission (304), in response to a first request, by the remote server and destined for the programmable device, of a response readable by the browser (107) and comprising the data, the target address and an instruction to redirect the data to the target address.

21. Method according to claim 20, in which the redirection instruction comprises a command designed to be executed by said browser.

22. Method according to claim 21, in which said command comprises a local command capable of being executed by the electronic unit.

23. Method according to claim 22, in which said local command complies with the ISO 7816 standard.

24. Server (110) comprising transmission means designed to transmit, in response to a first request and destined for a programmable device implementing a browser, a response readable by the browser and comprising data, a target address of a second server housed in an electronic unit linked to said programmable device and an instruction to redirect the data to the target address.

25. Method for transmission of data from a first server (131) housed in an electronic unit (130) linked to a programmable device (100) implementing a browser (107), to a second remote destination server (110) having a target address, characterized by a step for transmission (304), in response to a first request, by said first server (131) and destined for the programmable device (100), of a response readable by the browser (107) and comprising the data, the target address and an instruction to redirect the data to the target address.

26. Method according to claim 25, comprising an initial processing step carried out by said electronic unit so as to generate said data.

27. Electronic unit (130) comprising a first server (131) and connection means (134) to a programmable device (100) implementing a browser (107), said first server comprising:
transmission means designed to transmit, in response to a first request and destined for the programmable device, a response readable by the browser and comprising data, a target address of a second remote server and an instruction to redirect the data to the target address.

28. Electronic unit (130) according to claim 27, in which said connection means comprise an interface according to the ISO 7816 standard.

29. Electronic unit (130) according to claim 27, comprising cryptographic means and an associated encryption key designed to generate said data.
